(19) United States
(12) Patent Application Publication
(10) Pub. No.: US 2022/0281346 A1
(43) Pub. Date: Sep. 8, 2022

(54) MODULAR ENERGY DISTRIBUTION SYSTEM

(71) Applicant: EZRA GREEN, Massapequa, NY (US)

(72) Inventor: EZRA GREEN, Massapequa, NY (US)

(73) Assignee: Starlink Energy Systems, Inc., Zephyr Hills, FL (US)

(21) Appl. No.: 17/687,762

(22) Filed: Mar. 7, 2022

Related U.S. Application Data
(60) Provisional application No. 63/157,894, filed on Mar. 8, 2021.

(51) Int. Cl. B60L 53/68; B60L 53/51; B60L 53/52; H02J 7/34

(52) U.S. Cl. CPC B60L 53/68; B60L 53/51; B60L 53/52; H02J 7/342

(57) ABSTRACT

A method of distributing electricity to electric vehicle (EV) charging stations that are located a distance from a source of electricity. A mobile energy storage system (ESS) is charged at the source of electricity and then transported to the EV charging station. The EV charging station is then charged by the mobile ESS to produce a charged EV station for use by electric vehicles. The mobile ESS is then transported to other EV charging stations for charging these stations and when required transported back to the source of electricity for re-charging the mobile energy storage system (ESS) to then repeat the process of charging the EV charging stations. The EV charging stations need not, but can be connected to the electric utility grid system and/or may have a stationary ES S connected thereto. The charging stations can be freestanding and not dependent on a connection to the electric utility grid system.

### RELATED APPLICATIONS

This application claims priority of provisional applications 63/157,894 filed on Mar. 8, 2021. The entire disclosure of this application is incorporated herein by reference.

### FIELD OF THE INVENTION

This invention relates to a modular energy distribution system. In particular this invention relates to a mobile electric distribution system wherein the energy is distributed to predetermined points of use by mobile electric storage vehicles, e ., trucks with an energy storage system (“ESS”), for example a battery energy storage system (“BESS”) carried by the vehicles. Preferably the mobile electric storage vehicles are charged with renewable, solar generated, electricity. The mobile electric storage vehicles are transported to electric vehicle (“EV”) charging stations to charge these stations for use by electric vehicles. The EV charging stations need not, but can be connected to the electric utility grid system and/or may have a stationary ESS connected thereto. A primary benefit of this system is that the EV charging stations can be freestanding and not dependent on being connected to the electric utility grid system.

### BACKGROUND OF THE INVENTION

Climate scientists agree that vehicle electrification is one of the best ways to reduce planet-warming greenhouse gas emissions. In the United States, the transportation sector is the largest source of such emissions, most of which come from cars and trucks. Governments and automakers are now promoting electric vehicles (“EV”) as a key technology to curb oil use and fight climate change. Electric vehicles over their lifetime are generally lower in cost and emissions than the existing internal combustion engines. However, there still a reluctance to for consumers to invest in electric vehicles.

Typically, the upfront cost for an electric vehicle can be a barrier for many customers. The Federal government offers a tax credit for some new electric vehicle purchases, but this has a minimal impact on the initial purchase price of an EV. It is projected that electric vehicles will become more price competitive in the coming years as battery prices for such vehicles decrease. Most of today's electric vehicles use lithium-ion batteries, which can store more energy in the same space than the older, more commonly-used lead-acid battery technology and provide a longer range for cars.

General Motors has said it aims to stop selling new gasoline-powered cars and light, trucks by 2035 and will pivot to battery-powered electric vehicles. Volvo indicated it would move to introduce an all-electric line of EVs by 2030. Additionally, many municipalities are planning'to convert their internal combustion engine fleets to EV's by 2023. California governor has set as a goal phasing out sales of new combustion engines statewide in 15 years. Automakers like Tesla, Ford and Volkswagen plan to introduce dozens of new electric models in the years ahead, spurred on by plummeting battery prices and concerns about climate change.

The electric vehicle and the support market for electric vehicles is one of the fastest growing tech sectors. There is now an annual expansion of about one million EV units per year, i.e., a 30% to 50% annual growth. However, today, less than one percent of cars on America's roads are electric. Trucks powered by electricity will increase demand for electricity because they require at least eight times the amount of energy required by an electric automobile. It is predicted that a seismic shift to EVs will be taking place over the next few years.

For electric vehicles to go main stream, charging will need to be widely accessible and convenient. It is estimated that if every American switched over to an electric passenger vehicle, the United States would need roughly 25 percent more electricity than it uses today. With the existing generation and distribution systems, the utilities will likely need to build new power plants and upgrade their transmission networks and grid systems.

It is projected that millions of new cars and trucks over the next decade will be plugged into electrical outlets connected to the utility power grid. Each of these vehicles will need to be charged at an EV charging station. There is thus a tremendous need to provide an infrastructure that can support the explosive future needs for EV charging stations. The present power grid is not ready to handle this surge of new electric vehicles and EV charging stations.

The utility power grid is an interconnected network of power lines, transformers, transfer stations, etc. that electrically couple an energy provider to an energy consumer. Under the present system, as the need for EV charging stations increases, all of these EV charging stations will need to be “hard wired” to the utility power grid infrastructure. To develop such an infrastructure will take many years and will be expensive.

The electric power grid system has a limited capacity for storing electrical energy. Electricity must be constantly generated to meet uncertain demands. This results in over-generation of electricity (and hence wasted energy) and under-generation of electricity (and hence power failures).

For many utilities the challenge will also be dealing with not just how much, electricity new EVs are using and the infrastructure needed for them, but when they're actually using it. For example, if the electricity is obtained from solar power, during the day there may be a surplus of power that ramps down in the evening as the sun sets. If millions of electric cars came home in the evening and immediately started charging all at once, it would put a major strain on the electric grid system.

Additionally, the electric power grid system itself has become increasingly unreliable and antiquated, as evidenced by frequent large-scale power outages. A major blackout could dramatically affect travel when EVs are the dominant mode of travel. A challenge for utilities will be to get more creative about juggling exactly when and how electric vehicles charge their batteries, so that they don't all power up at the same time and overload electrical equipment and the grid or require the construction of costly new power plants.

There is also a need to increase the speed of charging. This will require an increase in the output of electricity from, for example, home charging from a standard AC outlet of 1.5 kilowatts of electricity to the planned 50 kilowatts of DC power to as high as 350 kilowatts of power to slash charging times to 10 to 15 minutes. With the present electrical grid system, with each EV charging station connected to the utility grid, utilities will have to drastically upgrade their infrastructure.

The EV industry has focused on growth of charging stations, their connection to the electric utility grid, the elements involved in battery storage devices for EVs, e.g., Lithium Cobalt batteries, and on the software related to the EV. However, a major factor in the growth of the EV industry will be the distribution of electricity by the utilities to the EV charging stations through power lines and grid systems connected to the EV charging stations.

The shift to EV will have significant implications for companies that produce and sell electricity and manage the grid. The present electric utility grid system is over a century old and, in its present state, will be incapable of supporting the increase in demand for electricity to support the projected EV market expansion.

To put this in perspective, the number of EV charging stations remains relatively low. According to the Department of Energy, there are just over 16,000 public EV charging points in the United States, offering about 44,000 individual outlets of varying charging speeds. By comparison, there are 120,000 gas stations nationwide, many of which have 10 or more pumps. Thus, a dramatic shift in providing EV charging stations is required before there can be the planned wide use of electric vehicles. In order for there to be a mass market for electric vehicles there must be a robust network of public charging stations.

It is also impractical for a home solar system to recharge an EV. More specifically, a 5 kW home solar system produces about 17 kWhs a day and less in winter and cloudy days, e.g., 10 kWh. An EV car battery holds 100 kWhs. That is 6-10 a full days solar output to recharge a car. With the present technology, it is a fallacy to believe that EVs will be powered at home by “free” solar power. It is also impractical to have a home electric storage system. The cost is about $350 per kWh, i.e., to hold a charge would require a storage system costing about $35,000.

These increased and projected demands that encourage battery and carport infrastructure to support EVs are now forcing regions to expand VDER/Stack programs wherein the electricity is provided to the electric grid system. For every 1 million, cars on the road, we need more than 30 million kWh's. It is estimated that by January 2022 there will be nearly 3.25 Million cars. This demand for electricity will only increase further as E-trucks are introduced.

The EV charging station infrastructure needs to be in place in a relatively short amount of time, i.e., in about two years. However, the utility electric grid system is about half the size it needs to be to meet the potential needs of EV. Such electric grid system upgrades are decade long ventures that include intensive planning, regulatory hurdles and billions of dollars of increased investment.

Therefore, what is needed is a system and method for using grid independent EV charging stations that can be easily charged for use by EVs.

The following references may be relevant to this invention:

U.S. Pat. No. 7,747,739 to Bridges et al.

U.S. Pat. No. 8,019,483 to Keefe.

U.S. Pat. No. 8,996,183 to Forbes Jr.

U.S. Pat. No. 9,302,590 to Santos Silva.

U.S. Pat. No. 9,369,082 to Huang et al

U.S. Pat. No. 9,600,790 to Mohagheghi et al.

U.S. Pat. No. 9,698,616 to Mohagheghi et al.

U.S. Pat. No. 9,849,800 to Theobald.

U.S. Pat. No. 10,622,809 to Kraft.

U.S. Pat. No. 10,763,692 to Pelletier et al.

US 2010/0181957 to Goeltner

US 2013/0200730 to Hewitt.

### DESCRIPTION OF THE DRAWINGS

Further aspects, features and advantages of the present invention will become more apparent with reference to the following detailed description and the accompanying drawings. The embodiments of the present invention illustrated in the accompanying drawings are examples of this invention and are not to be limited thereto. The drawings are not presented to scale but are used to illustrate the basic principles of the invention.

FIG. 1 is an embodiment of electrical schematic for charging a mobile energy storage system (“ESS”), for example a mobile battery energy storage system (“BESS”), from a utility service, e.g., solar, wind or conventional, that is then transported by, for example, a truck (FIG. 3), to a public or private charging station to charge a stationary ESS, for example a battery energy storage system (“BESS”), used to charge electric chargers for electric vehicles and/or to directly charge electric chargers for electric vehicles.

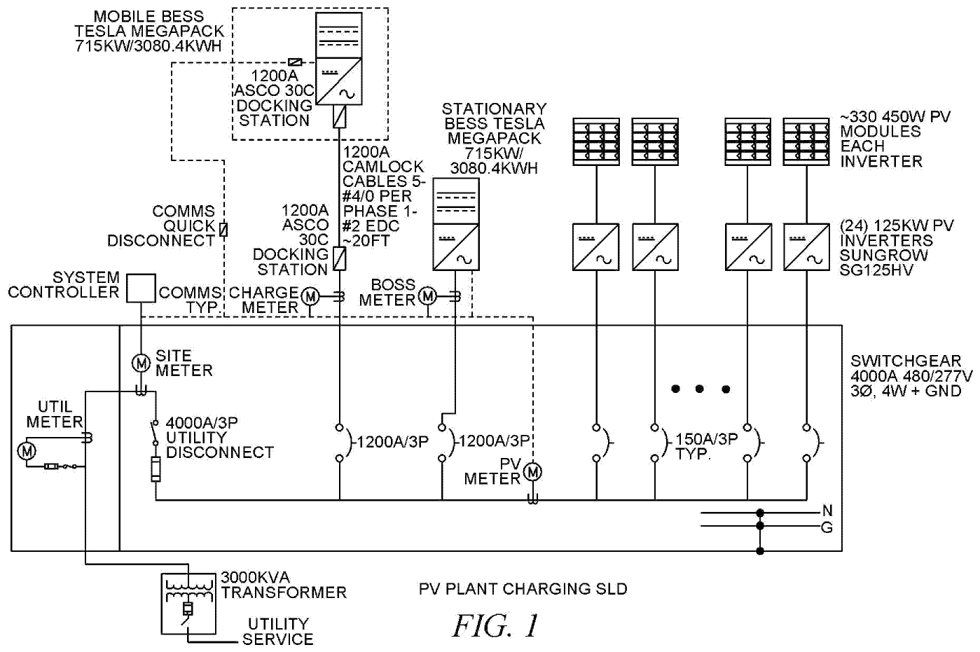

FIG. 2 is an electrical schematic for charging the mobile energy storage system (“ESS”), for example a mobile battery energy storage system (“BESS”), from a stationary ESS, e.g., BESS, that is then transported by, for example, a truck (FIG. 3), to a public or private charging station to directly charge electric chargers for electric vehicles.

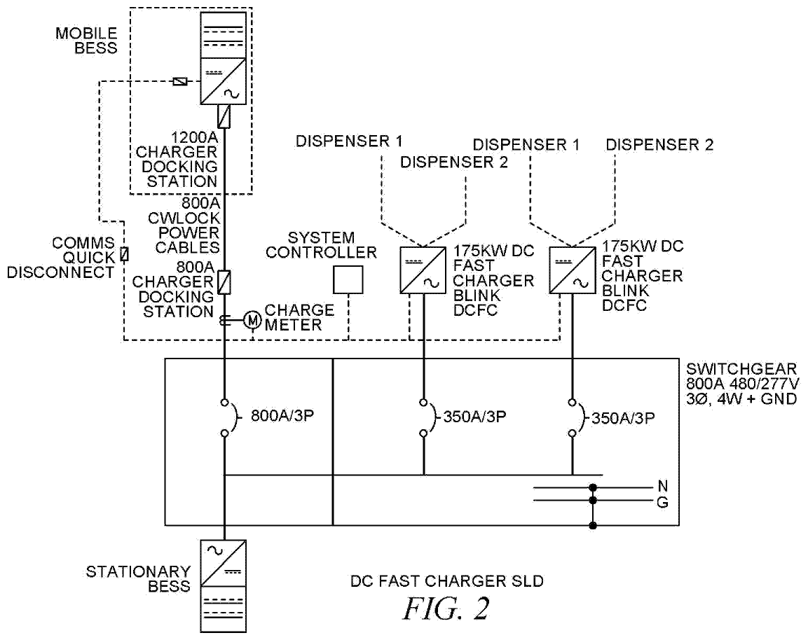

FIG. 3 is a schematic that includes an elevation view and top view of a public charging station showing a truck having a charged mobile ESS therein with associated accessories, at a public charging station charging a stationary ESS used to charge electric chargers for electric vehicles and/or to directly charge electric chargers, e.g., fast, level 2 or trickle chargers, for electric vehicles.

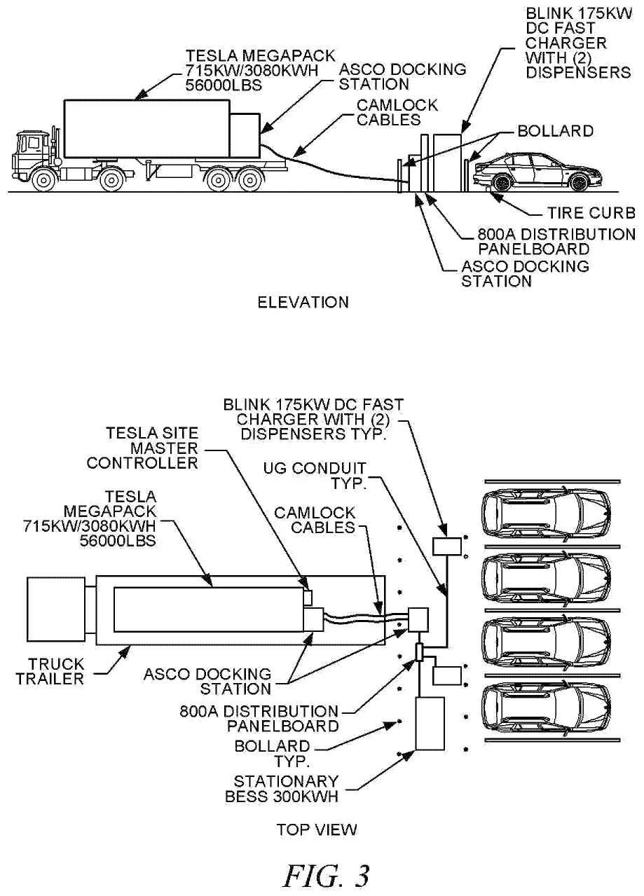

FIG. 4 is an electrical schematic wherein the mobile energy storage system (“ESS”) is at a public or private charging station that is used to charge the electric fast or level 2 charging stations.

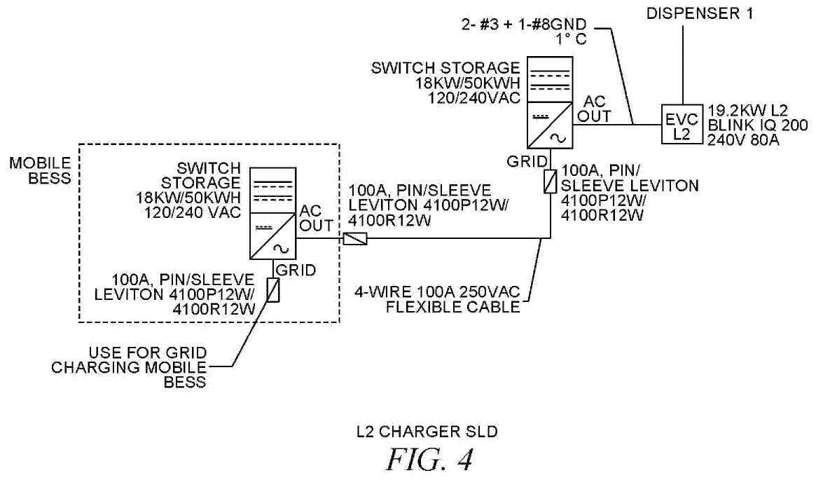

FIG. 5 is a schematic that includes an elevation view and top view of a truck or van having therein a mobile energy storage system (“ESS”), e.g., BESS, which charges a stationary ESS located at the public charging station that is used to charge the electric chargers at the charging station.

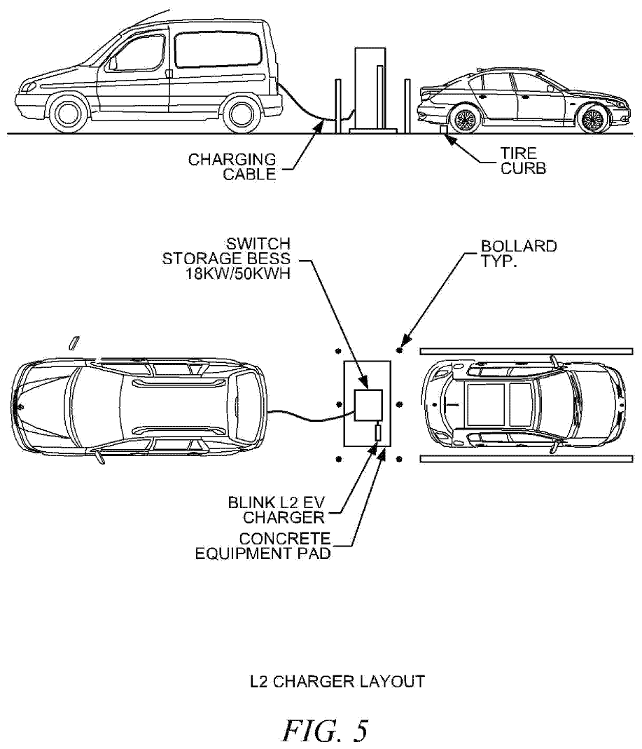

### SUMMARY OF THE INVENTION

This invention is directed to a modular energy distribution system and in particular a mobile electric distribution system and method of distributing electricity. In its preferred mode a renewable energy system, e.g., solar or wind, generates electricity that is stored on or near the renewable energy facility by an energy storage system (“ESS”), preferably a battery energy storage system (“BESS”). Mobile electric storage vehicles are provided at the facility. These vehicles include an energy storage system, preferably a battery energy storage system. The mobile electric storage vehicles are charged by the ESS and/or BESS at the renewable energy facility. The charged mobile electric storage vehicle then travels to EV charging stations to charge such stations from the mobile electric storage vehicle. The EV charging, station is charged by electrically connecting the mobile electric storage vehicle to the station(s) or by a “swap-out” of batteries from the mobile electric storage vehicle with the batteries in the EV charging station. An electric vehicle may then pull up to an EV charging station and charge its batteries.

More specifically. this invention is directed to a method of distributing, electricity for use in electric vehicles, comprising:
providing an electric charging station for electric vehicles;
providing a source of electricity a distance from the charging station;
providing a mobile energy storage system (ESS), e.g., BESS, capable of being charged;
charging the mobile ESS with the source of electricity to produce a charged mobile ESS;
transporting the charged mobile ESS to the electric vehicle charging station;
charging the electric vehicle charging station with the charged mobile ESS to produce a charged electric vehicle charging station for use by electric vehicles;
transporting the charged mobile ESS to another electric vehicle charging station; and
charging the other electric vehicle charging station with the charged mobile ESS to produce another charged electric vehicle charging station for use by electric vehicles

These steps are repeated until the mobile ESS is substantially discharged. The mobile ESS then travels to the source of electricity, is charged and then travels to other EV stations to charge them.

An important benefit of the mobile electric distribution system of this invention is that the EV charging stations do not need to be connected to a utility electrical grid system, i.e., they can be freestanding, positioned at any location, at any time without the need for the time consuming, expensive and complicated procedure of connecting the station to the electric utility grid system.

Optionally, the mobile electric storage vehicles may be charged and discharged at a utility station to assist in balancing the demand for electricity by the utility and/or the renewable energy system.

### DETAILED DESCRIPTION OF THE INVENTION

Broadly, the mobile electric distribution system of this invention comprises a source of electricity, preferably a renewable energy system such as a solar energy system or wind turbine energy system, although other type sources of energy may be utilized. The renewable source of electricity preferably has an on-site energy storage system (“ESS”), such as a battery energy storage system (“BESS”) which is charged by the renewable energy system.

A mobile electric storage vehicle is provided that has an energy storage system (ESS), preferably a battery energy storage system (BESS) that can be charged by the on-site energy storage system. The charged mobile electric storage vehicles then travels to the EV charging stations to off-charge to an ESS and/or BESS at the charging stations or directly to the charging stations. Each charging station includes a vehicle charging device which is plugged into the EV by the owner.

The source of electricity may be the typical electric utility, but is preferably a renewable energy system. The renewable energy system that produces the electricity may be solar, wind, hydroelectric power, heat, hydrogen, fuel cell geothermal energy, or biomass. The renewable energy system may be a stand-alone system or part of a micro grid or grid system tied to residential or commercial users. This energy or source energy is then transferred to a mobile unit.

A preferred renewable system is a DC system, preferably using photovoltaic panels or wind generated renewable energy. The system will produce DC electricity, which may or may not be converted to AC, depending upon whether it is tied to a grid. Preferably, the renewable energy system includes one or more solar cells, e.g., photovoltaic cells. These solar cells are configured to convert light energy into electrical energy. The solar cells may be arranged in one or more arrays, which may be further configured in one or more solar panels. Such solar panels and, thus, solar cells may be positioned on an open land area, a roof, etc. If a stand-alone renewable energy system is used herein, it would have a controller and converter with no D/C-A/C inverter. If it is grid tied it can be inverted or converted to AC and can also be bi-directional allowing for utility supplied electricity as, a source.

Permanently attached to the renewable energy system is an ESS or BESS for the purpose of rapid recharging of the mobile electric storage vehicles. For example, the electricity is produced from a solar panel system that is stored at the solar panel site. The energy may be stored at the solar site in a battery energy storage system (“BESS”) although other systems may be used. At this time, lithium-ion batteries are the chemical battery of choice used in the storage industry. The energy storage systems (ESS) used in this invention may be liquid salt, ceramic or any other energy storage device capable of storing energy to produce electricity or for storing electricity, e.g., a battery energy storage system (BESS). Other type batteries are being developed and can be used in this invention.

This energy or electricity may then be transported to a remote location for the discharge of the energy to the EV charging station.

The transfer of electricity for any of the steps of the invention can be done directly, e.g., by cable, or indirectly by the wireless transfer of energy. The energy can be transmitted through microwaves or any other source of energy transfer not requiring physical contact.

The energy stored at, for example, the solar site is accessed by mobile electric storage vehicles. e.g., trucks or vans, with accommodating couplings that connect and recharge the on-board energy storage system, e.g., batteries, ready for transport to client discharge destinations, e.g., EV stations. The mobile electric storage vehicles then couple with and discharge its stored on-board electricity into to the EV charging, stations that are available for charging electric vehicles.

A preferred mobile electric storage vehicle system includes a battery system, inverters, switchgear, power controllers and software for regulating the energy cells.

In the preferred system of this invention the energy is distributed to predetermined points, e.g., EV charging stations, through the use of mobile electric storage vehicles, e.g., trucks, vans, etc. that carry mobile battery storage units. preferably lithium-ion batteries, that are charged through a solar electric system. The mobile electric storage vehicles carry about approximately 2+ MWhs per vehicle and will have the ability for a battery swap out and/or recharge options at the EV station or source of electricity. The mobile electric or energy storage vehicles are movable storage units for electric power. The energy is transported between the producer/supplier of electricity, e.g., renewable energy systems, to the buyers and/or consumers, in particular charging stations for EVs. The mobile electric storage vehicles are loaded with batteries for transporting to EV charging stations. The mobile electric storage vehicle can be a passenger car, a truck, a bus, a train car, or a trailer. Any type mobile electric storage vehicle may be used.

For example the mobile electric or energy storage vehicle unit could be designed wherein the BESS is in the underbody in a trailer and, optionally, the mobile electric storage vehicle can also be powered electrically, i.e., the electrical energy being transported can be partially used to power the mobile electric storage vehicle.

The mobile electric storage vehicles after being charged by the renewable energy system will relocate to a point of discharge which will be for the purpose of supplying electricity to the EV/utility/microgrid community.

The points of use or clients for the mobile electric storage vehicles are EV charging stations and, for example, VDER/Stack programs wherein the electricity in the mobile electric storage vehicles is injected into the electric grid system, see, for example, https://www.nyserda.ny.gov/all-programs/programs/ny-sun/contractors/value-of-distributed-energy-resources.

The EV charging station may have its own electrical storage system (ESS) included in or attached to the EV charging station so that it is not dependent on the utility electric grid. The charging stations with such connected electric storage systems (ESS) will be able to discharge the electricity into an EV that is connected to the station.

Optionally, the mobile electric storage vehicles may be recharged or discharged at utilities that have VDER programs that require an offset of the demand and that will allow for the mobile electric storage vehicles to couple to its grid or trunk line. This is accomplished through an agreement with utilities for prearranged locations to be outfitted with couplings that connect to the mobile electric storage vehicles that feed the grid line at the critical time and location.

Many utilities have Demand Response Programs, for example on 48 hours' notice, wherein mobile electric storage vehicles can deliver and release the energy as contracted at premium rates. This allows for the full seasonal, technical and financial exploitation of the stored energy at a solar site in a BESS.

In addition, the mobile electric distribution system of this invention can assist utilities to promote mobile discharge programs wherein multiple mobile electric storage vehicles can be dispatched to multiple pre-selected sites for daily or weekly discharges to the utility grid.

The mobile electric distribution system of this invention has numerous benefits. The invention enables EV charging stations to be easily positioned along transportation routes without the need to be connected to the electric utility grid stem. The anxiety for drivers during their travels will decrease. The result will be more EV sales and use

The EV charging stations can be charged by mobile electric storage vehicles delivery of solar electricity to the EV charging stations, through community solar and or utility DRV based programs.

The mobile electric storage vehicles can have a rapid discharge system to the EV charging station or a “swap-out” of batteries in the mobile electric storage vehicle with the batteries in the charging station. This enables the EV charging station to provide inexpensive solar electricity to the EV.

The mobile solar electric distribution system of this invention allows the distribution of cost-protected solar electricity to EV charging stations or utility line zones on demand. Each charging station is monitored by an algorithm for usage and a low balance alert sends a request for recharging.

The mobile solar electric distribution system of this invention permits the mobile distribution of electricity on demand as required by certain utilities. The distribution system of this invention permits the exploitation of the variability of demand that is being experienced by the utilities. The distribution system of this invention can use drive-up hard-connected couplings to discharge to the utilities as well as the EV charging stations, which do not have to be connected to the utility electric grid.

The following is a proposed non-limiting example of the method of this invention and specifications therefore.

1. A mobile battery energy storage system (BESS) is charged at a regional renewable energy location. This can be solar+storage, solar, hydrogen or any means for the generation of electricity. Non-limiting examples of BESS/ESS units that may be used herein are available from Tesla®, Sungrow® and Powin®.

2. The BESS used herein ideally has an integrated inverter and can also power itself from its internal batteries so no auxiliary power is required while in transit or during docking, can be skid mounted to a standard 40 ft. ISO container base and use standard ISO container twist locks for attachment to the trailer.

3. The mobile unit carrying the BESS is dispatched to remote charging stations having chargers for EV that are not connected to the electric grid.

4. The BESS units need to be less than 80,000 lbs to meet standard tractor trailer towing limits.

5. The mobile BESS should be approximately 3MWh.

6. The EV charging stations should have 1-2˜200kW Level 3 DC fast chargers. 7. A control system may be employed to balance charging and discharging of the BESS at the various locations.

8. Alternatively, if there is a stationary BESS at the PV plant that is fully charged, it could be commanded to discharge while the mobile BESS is charging to fill in any drops in PV production, or to charge at night when there is no PV. The control system can also monitor and control the mobile BESS while discharging during EV charging.

The invention has been described with reference to various specific and illustrative aspects of the present invention and techniques. However, it should be understood that many variations and modifications may be made while remaining within the spirit and scope of the invention. Many alternatives, modifications and variations will be apparent to those skilled in the art in light of the foregoing description. Accordingly, this invention is intended to embrace all such alternatives, modifications, and variations that fall within the spirit and scope of the description.

1. A method of distributing electricity for use in electric vehicles, comprising:
providing an electric charging station for electric vehicles;
providing a source of electricity a distance from the charging station;
providing a mobile energy storage system (ESS) capable of being charged;
charging the mobile ESS with the source of electricity to produce a charged mobile ESS;
transporting the charged mobile ESS to the electric vehicle charging station; and
charging the electric vehicle charging station with the charged mobile ESS to produce a charged electric vehicle charging station for use by electric vehicles.

2. A method of distributing electricity for use in electric vehicles, comprising:
providing an electric charging station for electric vehicles;
providing a source of electricity a distance from the charging station;
providing a mobile energy storage system (ESS) capable of being charged;
charging the mobile ESS with the source of electricity to produce a charged mobile ESS;
transporting the charged mobile ESS to the electric vehicle charging station:
charging the electric vehicle charging station with the charged mobile ESS to produce, a charged electric vehicle charging station for use by electric vehicles;
transporting the charged mobile ESS to another electric vehicle charging station; and
charging the other electric vehicle charging station with the charged mobile ESS to produce another charged electric vehicle charging station for use by electric vehicles.

3. A method of distributing electricity for use in electric vehicles, comprising:
a. providing a plurality of electric charging stations for electric vehicles;
b. providing a source of electricity a distance from the charging stations;
c. providing a mobile energy storage system (ESS) capable of being charged:
d. charging the mobile ESS with the source of electricity to produce a charged mobile ESS;
e. transporting the charged mobile ESS to a first electric vehicle charging, station;
f. charging the first electric vehicle charging station with the charged mobile ESS to produce a charged first electric vehicle charging station for use by electric vehicles;
g. transporting the charged mobile ESS to another electric vehicle charging station;
h. charging the other electric vehicle charging station with the charged mobile ESS to produce another charged electric vehicle charging station for use by electric vehicles;
L repeating steps g. and h. until the mobile ESS is not substantially charged;
j. transporting the mobile ESS to the source of electricity;
k. charging the mobile ESS with the source of electricity to produce a charged mobile BESS; and
L repeating steps a. through k.

4. The method of claim 1, wherein the source of electricity is solar generated.

5. The method of claim 1, wherein the source of electricity is wind generated.

6. The method of claim 1, wherein the mobile ESS is a battery energy storage system (BESS).

7. The method of claim 2, wherein the mobile ESS is a battery energy storage system (BESS).

3. The method of claim 3, wherein the mobile ESS is a battery energy storage system (BESS).

9. The method of claim 1, wherein the electric vehicle charging stations are not connected to an electric utility grid system.

10. The method of claim 1, wherein the electric vehicle charging stations are connected to an electric utility grid system.

11. The method of claim 1, further comprising:
providing each electric vehicle charging station with a stationary ESS;
charging the stationary ESS with the charged mobile ESS to produce a charged stationary ESS;
charging the electric vehicle charging station with the charged stationary ESS to produce a charged electric vehicle charging station for use by electric vehicles.

12. The method of claim 11, wherein the mobile ESS and stationary ESS are each a battery energy storage system (BESS). 13 A method of distributing electricity for use by a customer, comprising:
providing an electric charging station for use by the customer;
providing a source of electricity a distance from the charging station;
providing a mobile energy storage system (ESS) capable of being charged;
charging the mobile ESS with the source of electricity to produce a charged mobile ESS;
transporting the charged mobile ESS to the charging station;
charging the charging station with the charged mobile ESS to produce a charged charging station for use by the customer;
transporting the charged mobile ESS to another charging station; and
charging the other charging station with the charged mobile ESS to produce another charged charging station for use by the customer.
